(19) United States
(12) Patent Application Publication
(10) Pub. No.: US 2022/0386616 A1
(43) Pub. Date: Dec. 8, 2022

(54) Combination of Encapsulated Phenothrin and Emulsified Prallethrin

(71) Applicant: Jesmond Holding AG, Zug (CH)

(72) Inventors: Miguel Gimeno Sierra, Berndorf (AT); Borjana Lubura, Wien (US)

(21) Appl. No.: 17/755,944

(22) PCT Filed: Nov. 13, 2020
(86) PCT No.: PCT/EP2020/082164

§ 371 Date: May 12, 2022

(30) Foreign Application Priority Data
Nov. 13, 2019 (AT) A50972/2019

(51) Int. Cl. A01N 53/00; A01N 25/04; A01N 25/28

(52) U.S. Cl. CPC A01N 53/00; A01N 25/04; A01N 25/28

(57) ABSTRACT

Disclosed is a combination of encapsulated, in particular micro-encapsulated phenothrin and emulsified prallethrin in water, preferably in a ratio of 10:1. This combination has excellent suitability for use as an insecticide. The suitable concentration is about 0.1% by mass of phenothrin and 0.01% by mass of prallethrin. The insecticide is used at a concentration of 20 ml/m² to 60 ml/m² on non-porous surfaces or in a concentration of 40 ml/m² to 120 ml/m² on porous surfaces. Despite the low amounts of active ingredients, the insecticide shows a rapid knockdown effect and a prolonged depot effect.

### TECHNICAL FIELD

The present teaching relates to a new water-based formulation comprising two active ingredients, i.e. phenothrin and prallethrin.

### BACKGROUND

Actually, the products that are currently on the market are in the form of emulsion in water or are present as emulsifiable concentrate intended for use in aerosols or as ready-to-use solution of active ingredients.

The following product combinations are available:

d-trans-tetramethrin 0.25%/d-phenothrin 0.125%;

d-trans-tetramethrin 0.20%/d-phenothrin 0.1%/PBO 0.90%;

d-trans-tetramethrin 0.33%/d-phenothrin 0.13%).

All these products have some weaknesses such as:

Low residual;

High degree of toxicity;

High exposure to human;

Higher concentration of active ingredient;

Complete availability of the product upon application leading to overdose;

No control of biodegradability of active ingredient;

High content of aromatic/aliphatic solvents;

No UV-protected;

Sensitive to organic matters in the environment;

Staining and not odourless.

Phenothrin (3-phenoxyphenyl)-methyl-(1R)-cis-trans-2,2-dimethyl-3-(2-methyl-1-propenyl) cyclopropanecarboxylate) belongs to the type 1 first generation synthetic pyrethroids. The structure is as it follows:

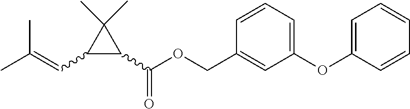 [SMILES: CC(C)=CC1C(C(=O)OCc2cccc(Oc3ccccc3)c2)C1(C)C]

It acts on the membrane of nerve cells by contact or ingestion, and thus it blocks the closure of the ion gates of the sodium channel during the re-polarization. This disrupts the transmission of nervous impulses. At low concentration the insect suffers from hyperactivity, while at high concentration it is paralyzed and dies.

Phenothrin, which firstly was registered by the EPA (EPA=United States Environmental Protection Agency) in 1976, is available as a ready-to-use (RTU) indoor spray and carpet powder, pressurized concentrate, emulsifiable concentrate, and is formulated for use in pet spot-on and stripe-on flea and tick treatments. Formulations for pet use often contain other active ingredients in addition to phenothrin. Phenothrin is also formulated for use with ULV sprayers (ULV=ultra-low volume) and indoor foggers. It is not very resistant to sunlight which shortens the residual effect and protection period.

Prallethrin (2-methyl-4-oxo-3-prop-2-yn-1-ylcyclopent-2-en-1-yl-2,2-dimethyl-3-(2-methylprop-1-en-1-yl)-cyclopropanecarboxylate) belongs to type 2 pyrethroids. It is a pyrethroid which reveals the property to trigger a fast knockdown against household insect pests. The structure is as it follows:

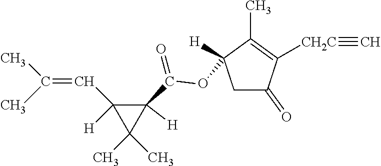

The main formulation types available are vaporizing mats (mosquito zapper) and liquid vaporizers.

There are products on the market containing phenothrin and prallethrin. However, there is no residual specified which is a clear hint that there is no residual, since a residual is highly desirable. Following is a list of products containing phenothrin and prallethrin, searched in the EPA data base:
DUET™ Dual-action (EPA Reg. No.: 1021-1795-8329)
Raid Flying insect (EPA Reg. No. 4822-569)
Raid Multi insect (EPA Reg. No. 4822-569) None of these shows a residual.

A formulation containing tetramethrin, d-phenothrin and piperonyl-butoxid is known from US 2015237861 A (see table 2). This formulation showed already after seven days after application insufficient residual, as can be seen from table 4 of this document. In example 2C of this document a formulation containing tetramethrin and d-phenothrin is specified, however, this formulation showed a significant loss of activity within three months, too.

A process for obtaining microcapsules is disclosed in U.S. Pat. No. 8,216,598 B by GAT Microencapsulation AG. The microcapsules can be obtained by emulsion polymerization in situ, thereby producing microcapsules of the polyurea-glycoluryl type.

Summary One object of the present teaching is to provide a formulation in order to allow the two active compounds phenothrin and prallethrin to act optimally.

According to the present teaching, the new formulation is a suspension of encapsulated phenothrin and an emulsion of prallethrin.

Thus, the formulation according to the present teaching can be understood as an application of the above-mentioned U.S. Pat. No. 8,216,598 B in order to obtain an environmentally friendly product which has a better activity, an extended residual effect and an improved toxicological profile.

In the above-described formulation, the release of phenothrin is done in a controlled manner providing a high persistence of action in the control of various crawling and flying insect pests such as black ants, fire ants, termite, silverfish, bedbugs, German and American cockroaches, houseflies, house spiders, mosquitoes, and tropical mosquitoes.

Presently, there is no product available for insect control, wherein two active ingredients, phenothrin microencapsulated as a long-acting agent and prallethrin emulsion in water as a fast-acting agent, are combined in a ZW formulation. (ZW is a mixture formulation of CS (capsule suspension) and EW (emulsion, oil in water). The marketed products considered to be most similar are EPA registered and consist of phenothrin in a free, non-microencapsulated form and prallethrin in the form of emulsion but also PBO as the additional component. Therefore, the product according to the present teaching has a considerable advantage: the product according to the present teaching surprisingly has a residual effect of at least eight weeks, even up to twelve weeks, which cannot be derived from the prior art. Studies have shown that the product according to the present teaching also shows a complete mortality after three months, tested in Musca domestica and Blattella germanica.

The mass ratio of phenothrin and prallethrin is preferably between 5:1 and 20:1 and in particular 10:1.

It is particularly preferred that phenothrin is microencapsulated, the specific particle size being at best between 1.8 μm and 3.3 μm. The particle size is determined by laser diffraction as volume-weighted average.

It has been found that this combination has an effective duration of at least eight weeks, in particular when the ratio is close to the optimum ratio of phenothrin to prallethrin of 10:1. Often, the lethal effect remains completely maintained for at least twelve weeks and only decreases after sixteen weeks. Nevertheless, the toxicity for humans and other warm-blooded animals is low, the microencapsulation making a significant contribution to this effect. The inhalation toxicity is also low because of microencapsulation.

By means of co-formulation with UV stabilizers it is also possible to ensure the UV stability, so that the long duration of activity is also ensured at points exposed to sun light. A suitable UV stabilizer is Es calo 551.

The time release characteristic can be optimally adjusted by the microencapsulation. It is therefore possible to work with lower amounts of the active ingredient in comparison with known products.

Accordingly, a concentrate may contain about 10% by mass of phenothrin and about 1% by mass of prallethrin. This concentrate is diluted 1:99 with water to obtain the ready-to-use final product. This final product then contains about 0.1% by mass of phenothrin and 0.01% by mass of prallethrin. This end product is outstandingly suitable as an insecticide. As will be proved below, the optimum application rates are around 25 ml/m² on non-porous surfaces and around 50 ml/m² on porous surfaces.

The release rate is governed by microcapsule particle size, the percentage of monomers, pre-polymers and the 3D cross-linker, as well as by wall thickness and wall permeability.

Storage stability is high, only marginal degradation occurring during storage.

Active ingredients have been made compatible through release rates and they were chosen based on their action behavior in order to balance efficacy, toxicity and stability of the product. It is a two-effect product via one single application, i.e. it shows a fast knockdown effect (paralysis of the insects) and reliable mortality.

The present teaching deals in particular with the special performance of the two active ingredients improving their intrinsic properties via process of microencapsulation and emulsion in water in order to elevate the knockdown and the residual effect. The final combination that was tested in depth contains phenothrin 0.1% and prallethrin 0.01% which was defined as the “end product”.

Prallethrin along with phenothrin in the combination can offer superior performance for household insect control.

TABLE 1

| Phenothrin Strengths: | Prallethrin Strengths: |
|---|---|
| Superior efficacy profile | Exceptional knockdown |
| Non-corrosive | Effective at very low rates |
| Biodegradable | Biodegradable |
| Application versatility | Application versatility |
| Favorable toxicity | Favorable toxicity |

There are currently 198 active registrations for phenothrin products in USA.

The concentration of phenothrin products on the market in USA and Canada are in a range between 0.096% as pet care spray or as flea killer in pump spray at the concentration of 1.3% with an estimated efficacy less than two months.

The main formulation type available is either oil-based or water-based aerosol. Both formulation types are often combined with synergists. In this regard many household products containing phenothrin are sold in aerosol spray cans containing inert propellants including propane and isobutante which are extremely flammable.

There are products which are available as RTU indoor sprayer or as carpet powder, pressurized or emulsifiable concentrate. Another type of use includes pet spot-on or stripe-on fleas and tick treatments with other active ingredients. Last but not least phenothrin based products can be used with ultra-low volume (ULV) sprayers and indoor foggers.

The use of residual surface applications of insecticides remains one of the most cost-effective and versatile means of controlling insect pests in the urban and household environment. The surfaces on which insecticides are applied vary greatly, and are typically porous. This can adversely affect the biological availability of insecticides. Other surfaces may, in addition, be chemically reactive and denature the active ingredient, compromising its persistence. Furthermore, insecticides applied to exterior surfaces are subject to further hostile conditions, most notably photodegradation, which can markedly reduce the persistence of the desired effect.

In the field of insect control, the end product is a proprietary combination of the slow-medium releasing characteristics whereby the release rate remains constant until the capsule is exhausted of the active.

Once the microcapsules containing phenothrin get in contact with an insect, the active ingredient rapidly diffuses into the lipophilic insect cuticle. Due to this fact, the behavior, and biological properties of phenothrin can be differentiated by employing microencapsulation technology.

Microcapsulated formulation confers the protection of phenothrin in order to diminish the potential of its degradation by sunlight. It releases periodically, ensuring this way a sustained release over time. This fact renders a better performance due to the availability of the active ingredient at a constant and more prolonged release rate.

Thus, the end product is a sophisticated dual-action household insecticide. It combines a proven efficacy of microencapsulated phenothrin with an exceptional knockdown activity of prallethrin. Due to it, the end product begins to work instantly.

Together, the active ingredients offer superior control mechanism, as the best performance of each of them is used in order to create an insecticide product, which yields unique results and increases the effectiveness in insect pest management and safety of the operator.

In summary, the end product has been formulated using microencapsulation technology to provide a product designed specifically for the urban and household environment with the following profile:
highly potent active ingredients
persistence of effect on a range of surfaces, including those which are highly porous and chemically reactive
rapid knockdown and kill.

In addition, the end product reveals a number of significant improvements in environmental and operator safety which are conferred by microencapsulation.

The end product may also encompass these further properties:
Sustainable formulation with antioxidant, UV-resistant due to the microencapsulation technology;
Immediate and timely controlled release lasting at least eight weeks as scientifically proven;
It does not degrade fast and thus it does not need to be re-applied often in order to maintain the lethal dose.

### Best Mode for Carrying Out the Present Teaching

### Examples for Formulations According to the Present Teaching

In this section the detailed composition of the microcapsules and of the emulsion necessary for the end product are disclosed. The following components are enclosed:

TABLE 2

| | component | CAS-number | function |
|---|---|---|---|
| A | 1R-trans-phenothrin TG | 26046-85-5 | active ingredient |
| | (typical 91.5% pure) | | |
| B | Prallethrin TG | 23031-36-9 | active ingredient |
| | (typical 93% pure) | | |
| C | BrijO20 | 9004-98-2 | emulsifier |
| D | Break Thru AF5503 | see SDS | anti-foam |
| E | Cycat 4040 | 67-63-0 | catalyst |
| F | Propylenglycol | 57-556 | antifreezing agent |
| G | TMXDI | 2778-41-8 | wall forming |
| | | | material |
| H | ONGRONAT 2100 | 2778-41-8 | wall forming |
| | | | material |
| I | CYMEL 1170 | 68036-98-6 | crosslinker |
| J | Proxel GXL | 2634-33-5 | preservative |
| K | Radia 7117 | 61788-59-8 | solvent |
| L | Synperonic PE/F 127 | 9003-11-6 | emulsifier |
| M | Xanthan Gum | 11138-66-2 | viscosity modifier |
| N | Zephrym PD3315 | see SDS | dispersant/crystal |
| | | | growth inhibitor |
| O | Water | 7732-18-5 | solvent |

In the following five examples, the following amounts (% weight) of the components A bis O were used:

TABLE 3

| | 1 | 2 | 3 | 4 | 5 |
|---|---|---|---|---|---|
| A | 10.644 | 10.644 | 10.644 | 10.644 | 10.644 |
| | (technical) | (technical) | (technical) | (technical) | (technical) |
| | 9.74 (pure) | 9.74 (pure) | 9.74 (pure) | 9.74 (pure) | 9.74 (pure) |
| B | 1.07 | 1.07 | 1.07 | 1.07 | 1.07 |
| | (technical) | (technical) | (technical) | (technical) | (technical) |
| | 0.9951 (pure) | 0.9951 (pure) | 0.9951 (pure) | 0.9951 (pure) | 0.9951 (pure) |
| C | 0.0187 | 0.0187 | 0.0187 | 0.0187 | 0.0187 |
| D | 0.015 | 0.015 | 0.015 | 0.015 | 0.015 |
| E | 0.15 | 0.15 | 0.18 | 0.25 | 0.25 |
| F | 5.00 | 8.00 | 7.50 | 9.00 | 10.00 |
| G | 0.15 | 0.15 | 0.3 | 0.4 | 0.10 |
| H | 1.00 | 1.05 | 1.40 | 1.50 | 0.80 |
| I | 0.10 | 0.10 | 0.25 | 0.30 | 0.18 |
| J | 0.10 | 0.10 | 0.10 | 0.10 | 0.10 |
| K | 4.80 | 4.50 | 5.0 | 6.00 | 8.00 |
| L | 0.50 | 0.75 | 0.84 | 0.92 | 0.84 |
| M | 0.40 | 0.40 | 0.35 | 0.30 | 0.30 |
| N | 3.0 | 3.35 | 3.0 | 3.35 | 2.80 |
| O | 73.0523 | 69.7023 | 69.3323 | 66.1323 | 64.8823 |

### EXAMPLE 1

### Preparation of Capsule Suspension (CS)

For 5 kg of the end product 1670 g CS are required. All figures are % by weight.

TABLE 4

| Oil phase | % weight | Water Phase | % weight |
|---|---|---|---|
| 1R-trans Phenothrin | 31.932 | Synperonic PE/F 127 | 1.5 |
| TMXDI | 0.450 | BrijO20 | 0.056 |
| ONGRONAT 2100 | 3.000 | Zephrym PD3315 | 3.0 |
| Cymel 1170 | 0.300 | Water | 44.912 |
| Radia 7117 | 14.400 | Cycat 4040 | 0.45 |

Maintain the water phase and the oil phase at 40° C. in a 2 litre jacketed reactor before the emulsion process.

In a jacketed reactor of 2 litre capacity, equipped with a cawless agitator and a high shear agitator, add the water phase at 40° C. With the cawless agitator on at 1600 rpm, the oil phase is added very fast (˜1 minute) to the water phase, starting the emulsion polymerization process.

After all the oil phase is emulsified completely, the high shear agitator is on at 4600 rpm. The emulsion polymerization is finished after 4 minutes.

Transfer the capsule suspension to the other jacketed reactor at 60° C., equipped only with an anchor agitator at 36 rpm.

The capsule suspension is maintained at 60° C. under the agitation for 3 hours until the capsules are cured and stable formed.

### Preparation of the Emulsion in Water (EVV)

For 5 kg of the end product 3330 g EW are required. All figures are % by weight.

TABLE 5

| | |
|---|---|
| Propylenglycol | 7.5 |
| Zephrym PD3315 | 3.0 |
| Xanthan Gum | 0.6 |
| Break Thru AF5503 | 0.0225 |
| Proxel GXL | 0.15 |
| Water | 87.1175 |
| Prallethrin TG | 1.61 |

In a jacketed reactor of 5 litre capacity, equipped with a high shear agitator, add all the components of the EW formulation, except Xanthan Gum and prallethrin.

Mix the initial components using the high shear agitator at 1200 rpm and heat up the solution at 40° C.

After the temperature reaches 40° C., add Xanthan Gum at 4600 rpm until the complete transparent gelification.

Add prallethrin technical heated at 40° C. under the agitation at 4600 rpm for 4 minutes obtaining a homogenous stable emulsion in water (EW).

Preparation of the Final Suspension of Capsules Mixed with the EW to Form a ZW Formulation

In a jacketed reactor of 6 Liter capacity, mix 1670 g of capsule suspension with 3330 g of the EW using an anchor agitator at 36 rpm for at least 4 hours until the suspension is equilibrated and stable.

Measure the particle size of ZW formulation using a laser diffraction equipment and the stability of the dispersion of the capsules in a hard water of 342 ppm at the ratio of use 1:99.

### EXAMPLE 2

### Preparation of Capsule Suspension (CS)

For 5 kg of the end product 1670 g CS are required. All figures are % by weight.

TABLE 6

| Oil phase | % weight | Water Phase | % weight |
|---|---|---|---|
| 1R-trans Phenothrin | 31.932 | Synperonic PE/F 127 | 2.25 |
| TMXDI | 0.450 | BrijO20 | 0.056 |
| ONGRONAT 2100 | 3.150 | Zephrym PD3315 | 3.00 |
| Cymel 1170 | 0.300 | Water | 44.912 |
| Radia 7117 | 13.500 | Cycat 4040 | 0.45 |

The manufacturing steps are the same as in example 1.

### Preparation of the Emulsion in Water (EVV)

For 5 kg of the end product 3330 g EW are required. All figures are % by weight.

TABLE 7

| | |
|---|---|
| Propylenglycol | 12 |
| Zephrym PD3315 | 3.52 |
| Xanthan Gum | 0.6 |
| Break Thru AF5503 | 0.0225 |
| Proxel GXL | 0.15 |
| Water | 82.0975 |
| Prallethrin TG | 1.61 |

The manufacturing steps for the water emulsion and for the final suspension are the same as in example 1.

### EXAMPLE 3

### Preparation of Capsule Suspension (CS)

For 5 kg of the end product 1670 g CS are required. All figures are % by weight.

TABLE 8

| Oil phase | % weight | Water Phase | % weight |
|---|---|---|---|
| 1R-trans Phenothrin | 31.932 | Synperonic PE/F 127 | 2.52 |
| TMXDI | 0.900 | BrijO20 | 0.056 |
| ONGRONAT 2100 | 4.200 | Zephrym PD3315 | 3.0 |
| Cymel 1170 | 0.75 | Water | 41.102 |
| Radia 7117 | 15.00 | Cycat 4040 | 0.54 |

The manufacturing steps are the same as in example 1.

### Preparation of the Emulsion in Water (EVV)

For 5 kg of the end product 3330 g EW are required. All figures are % by weight.

TABLE 9

| | |
|---|---|
| Propylenglycol | 11.25 |
| Zephrym PD3315 | 3.00 |
| Xanthan Gum | 0.525 |
| Break Thru AF5503 | 0.0225 |
| Proxel GXL | 0.15 |
| Water | 83.442 |
| Prallethrin TG | 1.61 |

The manufacturing steps for the water emulsion and for the final suspension are the same as in example 1.

### EXAMPLE 4

### Preparation of Capsule Suspension (CS)

For 5 kg of the end product 1670 g CS are required. All figures are % by weight

TABLE 10

| Oil phase | % weight | Water Phase | % weight |
|---|---|---|---|
| 1R-trans Phenothrin | 31.932 | Synperonic PE/F 127 | 2.76 |
| TMXDI | 1.20 | BrijO20 | 0.056 |
| ONGRONAT 2100 | 4.50 | Zephrym PD3315 | 3.0 |
| Cymel 1170 | 0.90 | Water | 36.902 |
| Radia 7117 | 18.00 | Cycat 4040 | 0.75 |

The manufacturing steps are the same as in example 1.

### Preparation of the Emulsion in Water (EVV)

For 5 kg of the end product 3330 g EW are required. All figures are % by weight.

TABLE 11

| | |
|---|---|
| Propylenglycol | 13.5 |
| Zephrym PD3315 | 3.52 |
| Xanthan Gum | 0.45 |
| Break Thru AF5503 | 0.0225 |
| Proxel GXL | 0.15 |
| Water | 80.7475 |
| Prallethrin TG | 1.61 |

The manufacturing steps for the water emulsion and for the final suspension are the same as in example 1.

### EXAMPLE 5

### Preparation of Capsule Suspension (CS)

For 5 kg of the end product 1670 g CS are required. All figures are % by weight.

TABLE 12

| Oil phase | % weight | Water Phase | % weight |
|---|---|---|---|
| 1R-trans Phenothrin | 31.932 | Synperonic PE/F 127 | 2.52 |
| TMXDI | 0.30 | BrijO20 | 0.056 |
| ONGRONAT 2100 | 2.40 | Zephrym PD3315 | 3.000 |
| Cymel 1170 | 0.54 | Water | 34.502 |
| Radia 7117 | 24.00 | Cycat 4040 | 0.75 |

The manufacturing steps are the same as in example 1.

### Preparation of the Emulsion in Water (EW)

For 5 kg of the end product 3330 g EW are required. All figures are % by weight.

TABLE 13

| | |
|---|---|
| Propylenglycol | 15.00 |
| Zephrym PD3315 | 2.70 |
| Xanthan Gum | 0.45 |
| Break Thru AF5503 | 0.0225 |
| Proxel GXL | 0.15 |
| Water | 80.0675 |
| Prallethrin TG | 1.61 |

The manufacturing steps for the water emulsion and for the final suspension are the same as in example 1.

### Critical Parameters for Microcapsule Selection

The selection of microcapsule for the stability and efficacy trials was based on the targeted properties defined for the end product.

The most critical property is the release rate of the microcapsules which is mainly controlled by:

1. Microcapsule size in μm

2. Degree of crosslinking (ratio wall-forming versus crosslinker)

3. Wall thickness (ratio polymer versus encapsulated oil phase);

4. Mobility of the oil phase as function of percent solvent.1.

Considering all the four listed properties, for each example prepared, the following data can be established:

TABLE 14

| | 1 | 2 | 3 | 4 | 5 |
|---|---|---|---|---|---|
| Particle size | medium/ | medium/ | low/ | low/ | medium/high |
| | high | high | medium | medium | |
| Degree of | high | high | medium | medium | low |
| crosslinking | | | | | |
| Wall thickness | low | low | high | high | low |
| Mobility of oil | medium | medium | medium | medium/ | high |
| phase | | | | high | |

Medium/high particle size implies low number of particles per unit volume;

low/medium particle size implies high number of particles per unit volume.

High degree of crosslinking implies slow release with a long residual efficacy;

medium degree of crosslinking implies fast release with a medium residual efficacy;

low degree of crosslinking implies fast release with a low residual efficacy.

High wall thickness implies medium diffusion;

low wall thickness implies high diffusion.

Therefore, one can conclude that in examples 1 and 2, number of particles per unit volume is low, therefore there is insufficient surface for delivery of the active ingredient which leads to a low efficacy; thus, this example is not acceptable for further testing.

In example 3, the number of particles per unit volume is high, which enables a surface of high(er) delivery of the active ingredient, leading to a higher efficacy. In addition, the particle size distribution is narrow, which allows a better dispersion stability. The degree of crosslinking gives a medium release profile with a high % of wall forming, enabling a medium diffusion that provides a residual efficacy. This example was the one chosen for further testing.

Example 4 is same as example 3, but it shows a less narrow particle size distribution and a higher mobility; this formulation would be also acceptable, but it is not ideal as this is the case for example 3.

In example 5, the number of particles per unit volume is medium to high. There is a medium surface available for the delivery of the active ingredient, with a low residual efficacy due to a very fast release profile. Thus, this example is not acceptable for further testing.

At the end, example 3 was chosen for further testing (e.g., efficacy, toxicity studies).

### Efficacy Studies Data (No Choice Test)—the End Product

The concentrate was diluted in a ratio of 1:99 to be applied as the ready to use formulation.

For the assessment of the residual efficacy of this end product in terms of knockdown and mortality, age adult insects of mixed sex have been used.

After the well shaking of the product prior to application, 100 ml/m² have been applied on carpet, concrete, and wood whereas 50 ml/m² were applied onto ceramic surfaces. The surfaces were stored under ambient conditions prior the use. The total surface treated was 1 m² to adhere as closely as possible to practical conditions. An untreated control (no product applied) was prepared in the same fashion for comparative purposes.

This was a “no-choice” test, whereby the insects were forced to stay on the treated surface. The persistence was measured by performing the same efficacy test after 4 and 8 weeks of the storage of the panels. Insects were checked for two purposes:
knockdown effect
lethal effect.

A complementary trial was performed by spraying directly the end product onto the target insects, whereby the immediate knockdown effect and mortality after 24 h were measured. In both cases the result was 100%.

On the spray treated surfaces, a 100% knockdown effect was observed
on day 0 after 15 min
after four weeks after 45 min
after eight weeks after 60 min

The killing rate was observed on four different surfaces (concrete, wood, carpet, ceramic tiles) for the following insects:

Musca domestica (house fly)

Aedes aegypti (yellow fever mosquito)

Culex pipiens (house mosquito)

Anopheles gambiae (tropical mosquito)

Blattella germanica (German cockroach)

Periplaneta americana (American cockroach)

Lasius niger (common black ant)

Ixodes ricinus (castor bean tick, a hard-bodied tick)

Ctenocephalides felis (cat flea)

Lepisma saccharina (silverfish)

Cimex lectularius (bedbug)

Tineola bisselliella (clothing moth)

Dermatophagoides pteronyssinus (house dust mites)

Tegenaria domestica (house spider)

Pediculus humanus (head louse)

On day 0 as well as after eight weeks the mortality was 100%.

Therefore, it was shown that after spray treatment at a dose of 50 ml/m² on non-porous surfaces and 100 ml/m² on porous surfaces there is
a very good insecticide effectiveness with a fast knockdown and a complete mortality;
a residual efficacy lasting at least eight weeks after treatment on various materials such as ceramic tiles, carpets, wood and concrete.

### Efficacy Studies Data (Simulated Use Trial)—the End Product—8 Weeks

Additional tests were conducted to mimic the realistic conditions to which the insects are exposed, and can move.

The test was conducted in four 15 m³ (6 m² floor) test chambers with four replicates in compliance with the standard BSI 4172 Part 1&2 concerning the hand-held pressurized insecticide testing (1993). The test chambers were maintained at the temperature of 26° C.±1° C. and a relative humidity of 70%±5% during the period of testing.

The test chamber materials were washable and non-porous material on the wall/ceiling and on the floor, respectively epoxy-painted steel, and ceramic tiles.

To stimulate what happens in premises, some polystyrene blocks and cardboards were set into the test chamber to be harborages and a water and food source with:
Water source (six 25 cm long water vials with a cotton wick)
Food source (four locations on the floor, under harborages, two Petri dishes with pet-food biscuit.

The insects were able to reach water and food sources without being in contact with the insecticide. They had many places to hide. Only the half of the area was treated thus the target organisms had the choice not to be in contact with the end product.

For each mode of treatment and repetition, batches were used as follows: 25 of each species, except for house spiders which were difficult to find and for whom only 5 were used per replicate including the corresponding untreated controls.

The control batches were intended to check the quality of the batches used for the tests and unintentional effects introduced by handling and experimental conditions.

The insects were released two hours after treatment to let enough time for the period to dry out.

The application was done using a professional sprayer GLORIA 81 with an anti-drop nozzle. The liquid was vigorously shaken between each treatment.

The application dose was 50 ml/m² and the treated area was half of the test chamber, i.e. 3 m²; then the quantity of product applied in each replicate was 150 ml of product per 3 m² area.

The pathway to the food and water sources was not treated.

Tests were performed for the following insects:

Musca domestica (house fly)

Aedes aegypti (yellow fever mosquito)

Culex pipiens (house mosquito)

Anopheles gambiae (tropical mosquito)

Blattella germanica (German cockroach)

Periplaneta americana (American cockroach)

Lasius niger (common black ant)

Solenopsis invicta (fire ant)

Reticulitermes santonensis (eastern subterranean termite)

Lepisma saccharine (silver fish)

Cimex lectularius (bedbug)

Tegenaria domestica (house spider)

On day 0 as well as after eight weeks the killing rate was 100%.

In the conditions of this simulated use trial, the end product applied at a rate of 50 ml/m² has proven a complete control in less than one week with a complete mortality at 100%. The residual efficacy has remained constant over a period of eight weeks after treatment.

### Efficacy Studies Data (Simulated Use Trial) for 12 and 16 Weeks—the End Product

Additional studies were conducted for evaluation of the efficacy and residual life of the end product which was applied to control various insect pests.

The trial was done in the laboratory in a test chamber with materials simulating the real conditions of use (cardboard=harborages+food/water source) and only the half of the area was treated by the product, thus the target organisms had the choice not to be in contact with the product.

The efficacy was quantified by a percentage of population's reduction after treatment and after 8 and 12 weeks.

Doses tested were 50 ml/m² for non-porous surfaces (ceramic tiles) and 100 ml/m² on porous surfaces (fiber-cement).

The chosen species for testing were Musca domestica (house fly) and Blattella germanica (German cockroach).

The product has proven a very good control in both target insect pest organisms with a complete kill (100%) until 12 weeks exposure time.

Testing for additional 4 weeks has shown a continuous efficacy in Musca domestica but only to a low extent in Blattella germanica:

TABLE 15

| | 8 weeks | 12 weeks | 16 weeks |
|---|---|---|---|
| Musca domestica | 100% | 100% | 100% |
| Blattella germanica | 100% | 100% | 17% |

### Toxicity Studies—the End Product

An acute oral toxicity test was conducted with rats to determine the potential for the end product to produce toxicity from a single dose via the oral route. Under the conditions of the study, the acute oral LD₅₀ of the end product is greater than 5000 mg/kg of body weight in female rats. All animals survived, gained body weight, and appeared active and healthy during the study. Based on the results, the end product meets the requirements for GHS Toxicity Category 5, i.e. no symbols and no specific label elements are required.

An acute inhalation toxicity test was conducted with rats to determine the potential for the end product to produce toxicity from a single exposure via the inhalation (nose-only exposure) route. Under the condition of the study, LC₅₀ of the test substance is greater than 5.03 mg/l in male and female rats. Based on the results, the end product meets the requirement for GHS Toxicity Category 5.

All animals survived exposure and gained body weight during the study. Following exposure, all rats exhibited irregular respiration. However, all animals recovered by day 2 and appeared active and healthy for the remained of the 14-day observation period. No gross abnormalities were noted for any of the animals when necropsied at the conclusion of the 14-day observation period.

The acute dermal toxicity was not tested as the lethal dose in rats for the concentrate has already revealed a value above 5000 mg/kg.

### Toxicity Studies—the Concentrate

Similar studies for the concentrate (10% phenothrin and 1% prallethrin) have revealed that the LD₅₀-value is above 5000 mg/kg body weight with the oral toxicity test as well as with the dermal acute toxicity test. This meets the requirements for GHS Toxicity Category 5, i.e. no symbols and no specific label elements are required.

In the study for an acute oral toxicity, all animals were observed for mortality, signs of gross toxicity, and behavioral changes at least once daily for 13 or 14 days. All animals have survived, gained body weight, and appeared active and healthy. There were neither signs of gross toxicity nor adverse pharmacologic effects or abnormal behavior.

In the study for an acute dermal toxicity, all animals were observed for mortality, signs of gross toxicity, and behavioral changes at least once daily for 14 days. All animals have survived the exposure and gained body weight. No gross abnormalities were noted for any of the animals when necropsied at the conclusion of the 14-day observation period.

In the study for acute inhalation toxicity, the values meet the requirements for GHS Toxicity Category 4. All animals have survived exposure to the test atmosphere. Following exposure, eight rats were hypoactive and in addition, all animals exhibited irregular respiration, an abnormal gait, and tremors (H332). However, all animals recovered by day 4 and appeared active and healthy for the remained of the 14-day observation period. Although several animals lost or failed to gain body weight by day 1, all animals gained body weight over the 14-day observation period. The observed body weight losses were not considered to be of toxicological importance. No gross abnormalities were noted for any of the animals when necropsied at the conclusion of the 14-day observation period.

### Storage Stability—the End Product and the Concentrate

Physical and chemical properties have been conducted in accordance with the OECD principles of good laboratory practice and the GLP principles of the Chemicals Act of Austria, 1996. The study has been conducted in 0.375 l polyethylene terephthalate (PET) spray bottles as final packaging material. Typical parameters as physical state, color, odor, active ingredients content, density, pH, wet sieve residue, persistent foam, particle size, pourability, dispersion stability as well as corrosion properties were determined. Four samples were analysed:
freshly prepared product
product after 4 freeze/thaw cycles for 18 hours at −10±2° C. and 6 hours at 20±2° C.
product after 7 days at 0±2° C.
product after 14 days at 54±2° C.

The end product as well as the concentrate were stable with these samples and accelerated aging.

### Evaluation of Anaerobic Biodegradation—the End Product

The anaerobic biodegradability of the end product in accordance to OECD 310:2014 was evaluated. Samples have been kept at the temperature of 20±2° C. for the whole period of the test (28 days).

Since the amount of TIC at the end of the test period was less than 10%, it is established that abiotic degradation has not occurred. In accordance to OECD 310:2014, the end product should be considered not biodegradable in aerobic conditions.

### Dose Finding Test Data in Non-Porous Surfaces

The purpose of this study was to assess several doses of the end product on non-porous surfaces against

Musca domestica (common house fly)

Blattella germanica (german cockroach) and

Tegenaria domestica (house spider).

The trial was done by exposing the insects on porous surfaces impregnated with different dosages at 12 ml/m², 25 ml/m² and 35 ml/m². In addition, a control was done, in which the surface was treated with water.

Some ceramic tiles of 15 cm×15 cm were treated with the product and the insects were exposed one hour on it. The experimenter recorded the mortality at regular time intervals.

The testing has revealed the following results:

On the tiles treated with water the mortality was lower than 5%, validating the trial.

On the tiles treated with 12 ml/m² the following percentages of insects were killed:

TABLE 16

| time | 1 h | 2 h | 3 h | 4 h | 5 h | 6 h | 7 h | 8 h | 24 h | 48 h | 72 h |
|---|---|---|---|---|---|---|---|---|---|---|---|
| Musca | 0 | 0 | 0 | 0 | 0 | 1 | 1 | 5 | 49 | 93 | 100 |
| domestica | | | | | | | | | | | |
| Blattella | 0 | 0 | 0 | 0 | 0 | 0 | 1 | 1 | 9 | 44 | 44 |
| germanica | | | | | | | | | | | |
| Tegenaria | 0 | 0 | 0 | 0 | 0 | 0 | 0 | 0 | 15 | 55 | 55 |
| domestica | | | | | | | | | | | |

It can be seen that this dosage is insufficient, because after 24 h not all insects were killed.

On the tiles treated with 25 ml/m², the following percentages were observed:

TABLE 17

| time | 1 h | 2 h | 3 h | 4 h | 5 h | 6 h | 7 h | 8 h | 24 h | 48 h | 72 h |
|---|---|---|---|---|---|---|---|---|---|---|---|
| Musca | 0 | 0 | 0 | 2 | 5 | 8 | 13 | 19 | 100 | 100 | 100 |
| domestica | | | | | | | | | | | |
| Blattella | 0 | 0 | 0 | 2 | 4 | 13 | 13 | 16 | 100 | 100 | 100 |
| germanica | | | | | | | | | | | |
| Tegenaria | 0 | 0 | 5 | 5 | 10 | 19 | 19 | 20 | 100 | 100 | 100 |
| domestica | | | | | | | | | | | |

This dosage is sufficient: after 24 hours, all insects are killed.

On the tiles treated with 35 ml/m² the following percentages were observed:

TABLE 18

| time | 1 h | 2 h | 3 h | 4 h | 5 h | 6 h | 7 h | 8 h | 24 h | 48 h | 72 h |
|---|---|---|---|---|---|---|---|---|---|---|---|
| Musca | 0 | 1 | 9 | 17 | 37 | 55 | 100 | 100 | 100 | 100 | 100 |
| domestica | | | | | | | | | | | |
| Blattella | 0 | 0 | 3 | 6 | 11 | 19 | 24 | 30 | 100 | 100 | 100 |
| germanica | | | | | | | | | | | |
| Tegenaria | 0 | 5 | 10 | 15 | 20 | 20 | 25 | 45 | 100 | 100 | 100 |
| domestica | | | | | | | | | | | |

By this dosage increase the efficacy was improved: the house fly was completely killed after 7 hours, and also for both other insects the dosage increase resulted in an improvement.

### Dose Finding Test Data in Porous Surfaces

The purpose of this study was to assess several doses of the end product on porous surfaces against

Musca domestica (common house fly)

Blattella germanica (German cockroach).

The trial was done by exposing the insects on concrete impregnated with different dosages at 25 ml/m², 35 ml/m² and 50 ml/m². In addition, a control was done, in which concrete was treated with water.

The experimenter recorded the mortality at regular time intervals.

The testing has revealed the following results:

On the concrete treated with water, the mortality was below 5%, validating the trial.

On the tiles treated with 25 ml/m² the following percentages were observed:

TABLE 19

| time | 1 h | 2 h | 3 h | 4 h | 5 h | 6 h | 7 h | 8 h | 24 h | 48 h | 96 h |
|---|---|---|---|---|---|---|---|---|---|---|---|
| Musca | 0 | 0 | 0 | 0 | 0 | 0 | 0 | 0 | 100 | 100 | 100 |
| domestica | | | | | | | | | | | |
| Blattella | 0 | 0 | 0 | 0 | 0 | 0 | 0 | 0 | 19 | 36 | 77 |
| germanica | | | | | | | | | | | |

It can be seen that this dosage is insufficient, because after 24 h not all insects were killed.

On the tiles treated with 35 ml/m², the following percentages were observed:

TABLE 20

| time | 1 h | 2 h | 3 h | 4 h | 5 h | 6 h | 7 h | 8 h | 24 h | 48 h | 96 h |
|---|---|---|---|---|---|---|---|---|---|---|---|
| Musca | 0 | 0 | 0 | 2 | 9 | 11 | 16 | 23 | 100 | 100 | 100 |
| domestica | | | | | | | | | | | |
| Blattella | 0 | 0 | 0 | 0 | 0 | 0 | 0 | 0 | 30 | 52 | 93 |
| germanica | | | | | | | | | | | |

In this case, more insects are killed after 24 hours, but not all. This dosage is therefore also insufficient.

On the tiles treated with 50 ml/m², the following percentages were observed:

TABLE 21

| time | 1 h | 2 h | 3 h | 4 h | 5 h | 6 h | 7 h | 8 h | 24 h | 48 h | 96 h |
|---|---|---|---|---|---|---|---|---|---|---|---|
| Musca | 0 | 0 | 3 | 11 | 16 | 22 | 28 | 47 | 100 | 100 | 100 |
| domestica | | | | | | | | | | | |
| Blattella | 0 | 0 | 0 | 0 | 5 | 8 | 12 | 17 | 100 | 100 | 100 |
| germanica | | | | | | | | | | | |

Here, the dosage is sufficient: after 24 hours, all insects are killed.

1. A combination of encapsulated phenothrin and emulsified prallethrin in water.

2. The combination according to claim 1, wherein the mass ratio of phenothrin to prallethrin is between 5:1 and 20:1.

3. The combination according to claim 1, wherein the phenothrin is microencapsulated.

4. The combination according to claim 3, wherein the specific particle size of phenothrin is between 1.8 μm and 3.3 μm.

5. The combination according to claim 1, wherein it is co-formulated with a UV stabilizer.

6. The combination according to claim 1, wherein the concentration of phenothrin is 9-11% by mass and the concentration of prallethrin is 0.9-1.1% by mass.

7. The combination according to claim 1, wherein the concentration of phenothrin is 0.09-0.11% by mass and the concentration of prallethrin is 0.009-0.011% by mass.

8. An insecticide comprising the combination according to claim 7.

9. A method or using the insecticide according to claim 8 comprising applying the insecticide at a concentration of 20 ml/m² to 60 ml/m² on non-porous surfaces.

10. A method of using of the insecticide according to claim 8 comprising applying the insecticide at a concentration of 40 ml/m² to 120 ml/m² on porous surfaces.

11. The combination according to claim 1, wherein the mass ratio of phenothrin to prallethrin is approximately 10:1.

12. An insecticide comprising the combination according to claim 1.

13. The insecticide according to claim 12 wherein it has a concentration of 20 ml/m² to 60 ml/m².

14. The insecticide according to claim 8 wherein it has a concentration of 20 ml/m² to 60 ml/m².
